(19) United States
(12) Patent Application Publication
(10) Pub. No.: US 2013/0264347 A1
(43) Pub. Date: Oct. 10, 2013

(54) THERMAL INSULATING STRUCTURE OF FUEL TANK FOR MOTOR VEHICLE

(71) Applicant: FTS CO., LTD., Aichi Prefecture (JP)

(72) Inventor: Shumei FUJITA, Aichi Prefecture (JP)

(73) Assignee: FTS CO., LTD., Aichi Prefecture (JP)

(21) Appl. No.: 13/857,073

(22) Filed: Apr. 4, 2013

(30) Foreign Application Priority Data
Apr. 10, 2012 (JP) 2012-089273

(51) Int. Cl. B60K 15/03; B32B 1/02

(52) U.S. Cl. CPC B60K 15/03177; B32B 1/02
USPC 220/562; 428/36.5

(57) ABSTRACT

A thermal insulating structure of a fuel tank for a motor vehicle, which is readily produced and attached without using any protector for a thermal insulating member. In the thermal insulating structure of the fuel tank mounted under a floor panel of the motor vehicle, at least an entire side surface and an entire bottom surface of the fuel tank are covered with a thermal insulating member that is formed previously. The thermal insulating member includes a foamed layer on an interior side thereof, and an outer layer made of a solid material. The thermal insulating member is attached to the floor panel along with the fuel tank by means of a tank attaching member.

### CROSS-REFERENCE TO RELATED APPLICATION

This application is related to and claims priority from Japanese patent application No. 2012-089273, incorporated herein by reference.

### BACKGROUND OF THE INVENTION

1. Field of the Invention

The present invention relates to a thermal insulating structure of a fuel tank for a motor vehicle, which is mounted under a floor panel of the motor vehicle.

2. Description of Related Art

Conventionally, a fuel tank for a motor vehicle has been frequently mounted under a floor panel for saving a space therefor. Under the floor panel, exhaust pipes, etc. have been also mounted so that heat of the exhaust pipes, etc. is transmitted to the fuel tank. In order to prevent the increase in temperature of the fuel tank, thermal insulation has been carried out thereagainst.

As shown in FIG. 1, for example, in order to enhance the thermal insulating properties of a fuel tank 10 that is mounted under a floor panel 12, the fuel tank 10 is formed to have a double structure composed of an inner tank 14 and an outer tank 16 (see publication of unexamined Japanese patent application No. 2006-199072, for example.). And supporting protrusions 18 and 20 are provided in an upper interior surface and a lower interior surface of the outer tank 16, whereas recesses 22 and 24 are provided in an upper exterior surface and a lower exterior surface of the inner tank 14. By fitting the supporting protrusions 18 and 20 in the recesses 22 and 24, the inner tank 14 and the outer tank 16 are assembled with a predetermined spacing, thereby defining a double structure.

In this example, however, two tanks, that is, the inner tank 14 and the outer tank 16, must be provided so that it takes time and labor for producing them, and the entire weight of the fuel tank 10 increases because of a double structure, which is contrary to demands for decrement in weight of the motor vehicle.

In another conventional example, as shown in FIG. 2, a fuel tank 26 is attached to a vehicle body 28 by means of an attaching band 30, and the attaching band 30 is covered with a thermal insulating cover 32 (see publication of Japanese Utility model application No. Hei 5-22137, for example.). In this example, the attaching band 30 is secured to the lower surface of the fuel tank 26 by fitting one end thereof in an engaging hole of the vehicle body 28, and screwing the other end thereof on a hook bolt 34 that is fitted in the vehicle body 28. And the thermal insulating cover 32 is secured to about a center of the attaching band 30 with a bolt 36 via a connecting member 38.

In this example, only the lower surface of the fuel tank 26 except for an upper surface and side surfaces thereof is covered with the thermal insulating cover 32 so that a sufficient thermal insulating effect has not been achieved. In addition, gaps are defined between ends of the thermal insulating cover 32 and the vehicle body 28 so that air enters these gaps to deteriorate the thermal insulating effect.

In still another conventional example shown in FIG. 3, in order to overcome the above-described problems, a main body 40 of a fuel tank 42 is entirely covered with a thermal insulating member 44 (see publication of Japanese Patent application No. 2009-67223, for example.). The thermal insulating member 44 is composed of an upper thermal insulating member 46 and a lower thermal insulating member 48. The upper thermal insulating member 46 and the lower thermal insulating member 48 are formed separately, and the main body 40 is covered therewith. Then, the upper thermal insulating member 46 and the lower thermal insulating member 48 are welded to the main body 40.

As a result, the upper thermal insulating member 46 and the lower thermal insulating member 48 are joined to each other along facing end edges 50 thereof.

This example requires the processes of forming the upper thermal insulating member 46 and the lower thermal insulating member 48 separately, and joining them along the facing end edges 50 so as to take significant time and labor, and cause the increase in production costs.

In a further conventional example shown in FIG. 4, in order to overcome the above-described problems, a bottom surface and side surfaces of a main body 52 of a fuel tank 54 are covered with a thermal insulating member 56, whereas an upper surface of the main body 52 is brought into contact with a floor panel 12. Then, the fuel tank 54 is secured to the floor panel 12 with ends of the thermal insulating member 56 being brought into contact with the floor panel 12 by means of a tank band 58 (see publication of Japanese Patent application No. 2011-63127, for example.).

These conventional examples shown in FIGS. 3 and 4, however, exhibit problems that stones, etc. sprung up from road surfaces during running of motor vehicles may strike the thermal insulating members 44 and 56, or the thermal insulating members 44 and 56 may interfere with road surfaces during running of motor vehicle on uneven road surfaces. In order to protect the thermal insulating members 44 and 56, as shown in FIG. 4, a protector 60 must be provided under lower surfaces of the fuel tanks 43 and 54 separately from the thermal insulating members 44 and 56 so that it takes significant time and labor, and the production costs increase.

### SUMMARY OF THE INVENTION

Accordingly, it is an object of the present invention to provide a thermal insulating structure of a fuel tank for a motor vehicle, which is readily produced and attached without using any protector for a thermal insulating member.

According to a first aspect of the present invention, in a thermal insulating structure of a fuel tank mounted under a floor panel of a motor vehicle, at least an entire side surface and an entire bottom surface of the fuel tank are covered with a thermal insulating member that is formed previously. The thermal insulating member includes a foamed layer on an interior side thereof, and an outer layer made of a solid material. The thermal insulating member is attached to the floor panel along with the fuel tank by means of a tank attaching member.

With the arrangement of the first aspect of the present invention, in the thermal insulating structure of the fuel tank mounted under the floor panel of the motor vehicle, at least an entire side surface and an entire bottom surface of the fuel tank are covered with a thermal insulating member that is formed previously. Therefore, the side surface and the bottom surface of the fuel tank can be covered completely, and consequently, an excellent thermal insulating effect is achieved. Since the thermal insulating member is previously formed to have a configuration conforming to that of the fuel tank, the attaching work of the thermal insulating member to the fuel tank is facilitated, and since no gap is generated between a side portion and a bottom portion of the thermal insulating member, a preferable thermal insulating effect can be achieved.

Since the thermal insulating member includes a foamed layer provided on the interior side thereof, and an outer layer made of a solid material, the exterior surface of the thermal insulating member exhibits high rigidity so that when stones, etc. sprung up from road surfaces during running of motor vehicles strike the thermal insulating member, and when the thermal insulating member interferes with road surfaces during running of motor vehicles on uneven road surfaces, etc., damage to the thermal insulating member can be prevented.

Since the thermal insulating member is attached to the floor panel along with the fuel tank by means of a tank attaching member so that when the fuel tank is attached, the thermal insulating member can be also attached by attaching the thermal insulating member to the fuel tank, thereby facilitating the attachment of the fuel tank and the thermal insulating member.

According to a second aspect of the present invention, an upper surface of the fuel tank is covered with another thermal insulating member having a foamed layer.

With the arrangement of the second aspect of the present invention, the upper surface of the fuel tank is covered with another thermal insulating member having a foamed layer so that the upper surface of the fuel tank along with side surfaces and a bottom surface thereof can be covered with the thermal insulating members, and consequently, the surfaces of the fuel tank can be entirely covered with the thermal insulating members. As a result, the thermal insulating effect can be achieved efficiently.

According to a third aspect of the present invention, an upper surface of the fuel tank contacts the floor panel, and an end of a side portion of the thermal insulating member contacts the floor panel.

With the arrangement of the third aspect of the present invention, the upper surface of the fuel tank contacts the floor panel, and the end of the side portion of the thermal insulating member contacts the floor panel. Since the upper surface of the fuel tank is covered with the floor panel, and interior decoration members such as carpets, etc. are mounted to the vehicle compartment side of the floor panel to achieve a thermal insulating effect, the upper surface of the fuel tank can be thermally insulated without being covered with any thermal insulating member. Since no thermal insulating member adapted to cover the upper surface of the fuel tank is required, the light-weight thermal insulating member can be provided with decreased production costs.

According to a fourth aspect of the present invention, the thermal insulating member has holes for passing members attached to an outer surface of the fuel tank therethrough.

With the arrangement of the fourth aspect of the present invention, the thermal insulating member has holes for passing members attached to an outer surface of the fuel tank therethrough. Therefore, the members adapted to be attached to the outer surface of the fuel tank can be readily attached after passing them in the holes of the thermal insulating member, and consequently, when members such as inlet pipes, fuel hoses, etc. are attached to the fuel tank, no gap is generated between the fuel tank and the thermal insulating member, thereby improving the thermal insulating effect.

According to a fifth aspect of the present invention, the outer layer is composed of an olefin synthetic resin or a blending material of olefin synthetic resins, and has a thickness ranging from 0.5 mm to 2.0 mm.

With the arrangement of the fifth aspect of the present invention, the outer layer is composed of an olefin synthetic resin or a blending material of olefin synthetic resins, and has a thickness ranging from 0.5 mm to 2.0 mm. Therefore, the outer layer exhibits sufficient rigidity and durability, and can prevent damage to the foamed layer. In addition, the increase in weight, which is caused by the outer layer, can be restrained.

According to a sixth aspect of the present invention, the foamed layer is composed of an olefin synthetic resin or a blending material of olefin synthetic resins, and has an expansion ratio ranging from 15 to 40.

With the arrangement of the sixth aspect of the present invention, the foamed layer is composed of an olefin synthetic resin or a blending material of olefin synthetic resins so that where both the foamed layer and the outer layer are composed of the olefin synthetic resin or the blending material of olefin synthetic resins, they are bonded to each other strongly.

Since the expansion ratio of the foamed layer ranges from 15 to 40, sufficient thermal insulating properties can be achieved, and a light-weight thermal insulating member can be realized.

According to a seventh aspect of the present invention, a tank attaching member is a plurality of belt members adapted to hold a bottom portion of the thermal insulating member in a plurality of positions, and ends of each of the belt members are secured to the floor panel.

With the arrangement of the seventh aspect of the present invention, the tank attaching member is a plurality of belt members adapted to hold a bottom portion of the thermal insulating member in a plurality of positions, and ends of each of the belt members are secured to the floor panel. Therefore, the fuel tank and the thermal insulating member can be held stably by means of a plurality of belt members according to the configuration of the fuel tank. The belt members having a belt-like shape can bend according to the configuration of the fuel tank to hold the fuel tank and the thermal insulating member securely.

In accordance with the present invention, the thermal insulating member is composed of a foamed layer provided on the interior side thereof, and an outer layer made of a solid material so that the exterior surface of the thermal insulating member exhibits high rigidity to prevent damage to the thermal insulating member during running of a motor vehicle.

The thermal insulating member is secured to the floor panel along with the fuel tank by means of the tank attaching member so that when the fuel tank is attached, the thermal insulating member can be also attached by attaching the thermal insulating member to the fuel tank, thereby facilitating the attachment of the fuel tank and the thermal insulating member.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a sectional view showing an attaching state of a conventional fuel tank to a floor panel;

FIG. 2 is a sectional view showing an attaching state of another conventional fuel tank along with a thermal insulating member to a floor panel;

FIG. 3 is a sectional view showing an attaching state of a thermal insulating member to still another conventional fuel tank;

FIG. 4 is a sectional view showing an attached state of a further conventional fuel tank along with a thermal insulating member to a floor panel;

FIG. 5 is a sectional view of a fuel tank and a thermal insulating member in a first embodiment of the present invention, which are attached to a floor panel;

FIG. 6 is a perspective view of an upper thermal insulating member adapted to be used in the first embodiment of the present invention;

FIG. 7 is a perspective view of a thermal insulating member adapted to be used in the first embodiment of the present invention;

FIG. 8 is an enlarged sectional view of the thermal insulating member adapted to be used in the first embodiment of the present invention;

FIG. 9 is a perspective view of a fuel tank adapted to be used in the present invention.

FIG. 10 is a sectional view of a fuel tank and a thermal insulating member in a second embodiment of the present invention, which are attached to a floor panel; and

FIG. 11 is a perspective view of a thermal insulating member adapted to be used in the second embodiment of the present invention.

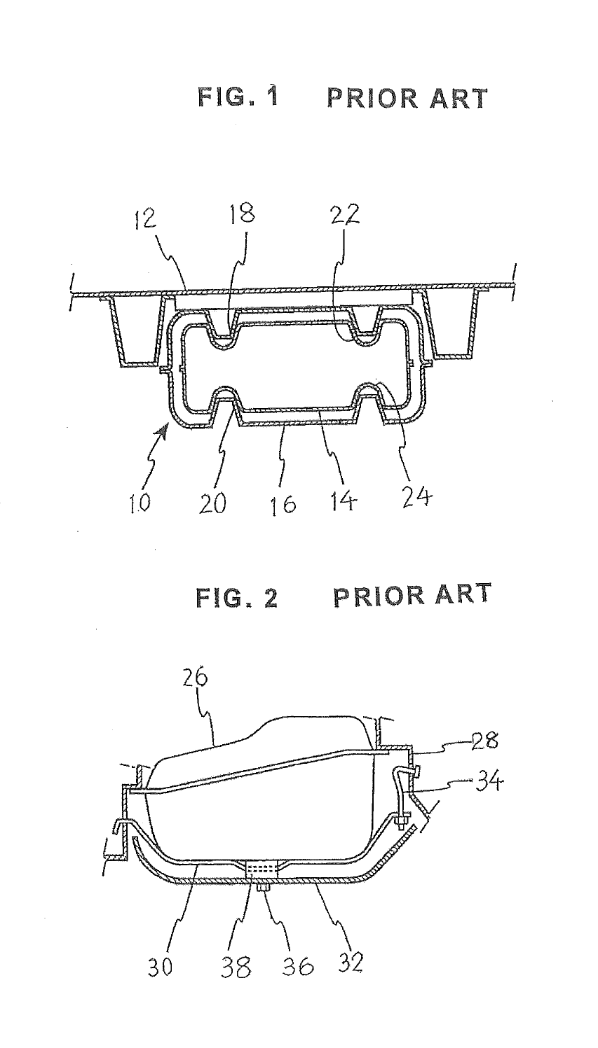

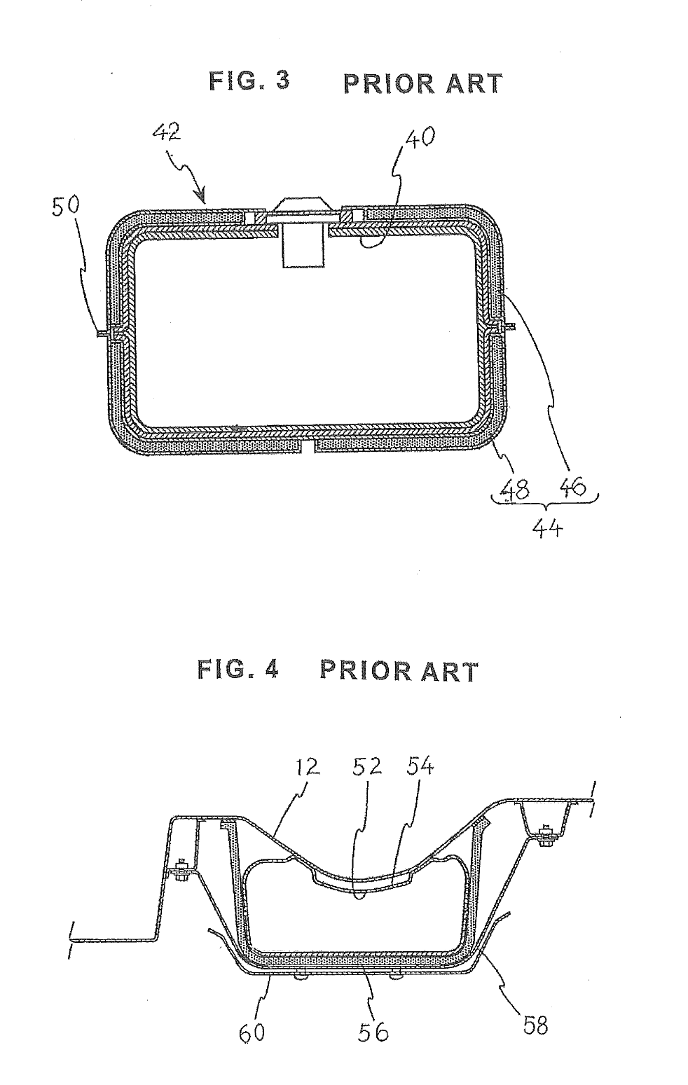

### DETAILED DESCRIPTION OF THE PREFERRED EMBODIMENTS

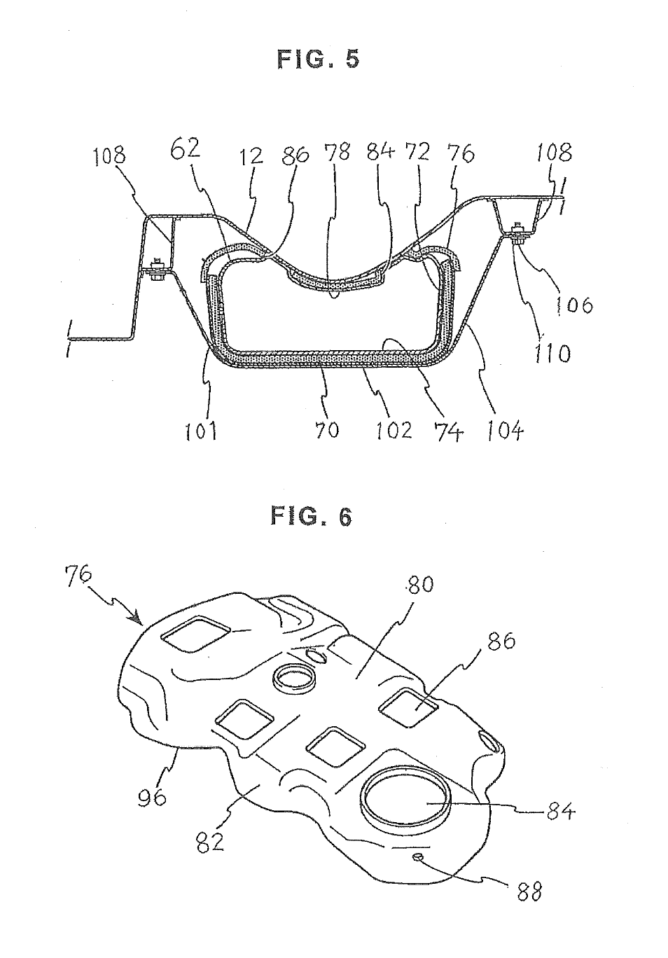

Hereinafter, embodiments of a thermal insulating structure of a fuel tank for a motor vehicle in accordance with the present invention will be explained with reference to FIGS. 5 through 11.

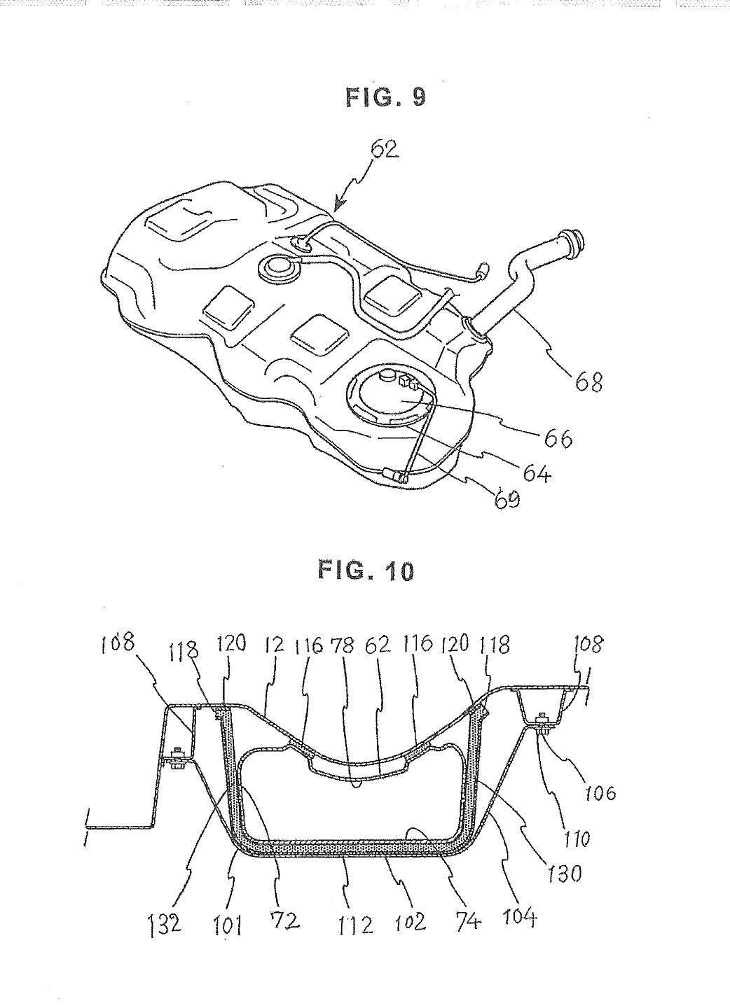

As shown in FIG. 9, a fuel tank 62 for use in the first embodiment has a pump unit attaching port 64 through which a fuel pump (not shown), etc. are adapted t to be inserted in and removed from the fuel tank 62 in an upper surface thereof. And a pump unit attaching cap 66 is attached for closing the pump unit attaching port 64, and attaching the fuel pump within the fuel tank 62.

In addition, an inlet pipe connecting member 68 is attached to the fuel tank 62 for connection with an inlet pipe (not shown) adapted to inject fuel from a fuel filler opening (not shown) provided in a vehicle body into the fuel tank 62. A fuel pipe 69 adapted to supply fuel to an engine from the fuel pump is also attached to the fuel tank 62. And, electric cords adapted to drive the fuel pump, and various pipes adapted to adjust an evaporated fuel within the fuel tank 62 are attached to the fuel tank 62.

The fuel tank may be made of metal or synthetic resin. In accordance with the present invention, the fuel tank made of metal or synthetic resin can be used.

In the case of metal, steel or stainless steel can be used.

Where the fuel tank 62 is made of synthetic resin, the fuel tank 62 may be composed of a single layer of a high density polyethylene (HDPE), or multiple layers including an outer layer, a barrier layer and a main layer. In the case of multiple layers, it is preferable to form the outer layer and the main layer of a thermoplastic synthetic resin exhibiting great shock resistance and maintaining rigidity against a fuel oil, in particular, a high density polyethylene (HDPE). And it is preferable to form the barrier layer of a thermoplastic synthetic resin such as a copolymer of ethylene vinyl alcohol (EVOH), polybutylene terephthalate, polyphenylene sulfide (PPS), etc.

Next, a first embodiment of a thermal insulating member 70 adapted to cover the fuel tank 62 for thermal insulation will be explained with reference to FIGS. 5 through 8.

As shown in FIGS. 5 through 7, the thermal insulating member 70 of the present embodiment is formed so as to cover a side portion 72 and a bottom portion 74 of the fuel tank 62, and an upper thermal insulating member 76 adapted to cover an upper portion 78 of the fuel tank 62 is used.

As shown in FIG. 6, the upper thermal insulating member 76 includes an upper surface 80 adapted to cover the upper portion 78 of the fuel tank 62, and a side surface 82 adapted to cover an upper half of the side portion 72. And a pump unit hole 84 for facing the pump unit attaching port 64 provided in the upper section 78 of the fuel tank 62, and pipe holes 86 and 88 for facing attaching positions of various pipes are formed in the upper thermal insulating member 76.

The upper thermal insulating member 76 includes only a foamed layer. Foamed bodies of polyethylene, polypropylene, polystyrene, polyurethane, phenol formaldehyde resin, etc., which are materials of the same kind with that of the material for a later-described outer layer, can be used as the material for the foamed layer. It is preferable to use polyethylene, polypropylene or a blending material thereof. The expansion ratio of the foamed layer ranges from 15 to 40. Since the expansion ratio ranges from 15 to 40, sufficient thermal insulating properties can be achieved, and the weight reduction can be realized.

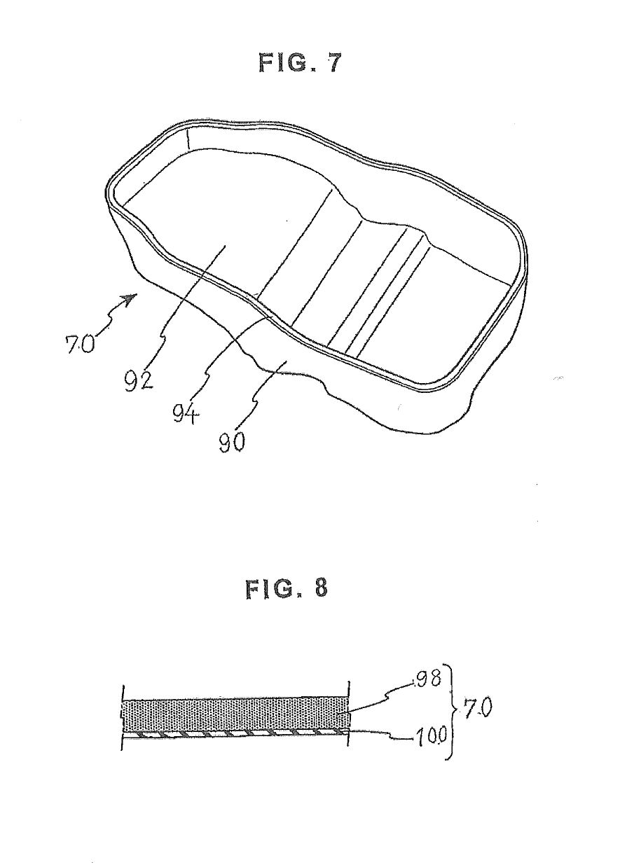

As shown in FIG. 7, the thermal insulating member 70 adapted to cover the side portion 72 and the bottom portion 74 of the fuel tank 62 is formed to conform to the configuration of the fuel tank 62, and a side section 90 adapted to cover an entire side surface of the fuel tank 62, and a bottom section 92 adapted to cover an entire bottom surface of the fuel tank 62 are integrally formed. The thermal insulating member 70 are formed by previously molding later-described two sheets with vacuum molding, etc. so as to conform to the configuration of the fuel tank 62.

Therefore, the thermal insulating member 70 can completely cover the side portion 72 and the bottom portion 74 of the fuel tank 62 to achieve an excellent thermal insulation effect. Since the thermal insulating member 70 is previously formed to have a configuration conforming to that of the fuel tank 62, the thermal insulating member 70 can be attached to the fuel tank 62 by merely fitting the thermal insulating member 70 on the fuel tank 62, thereby facilitating the attaching work. In addition, there is no gap between the side portion 72 of the fuel tank 62 and the side section 90 of the thermal insulating member 70, and between the bottom portion 74 of the fuel tank 62 and the bottom section 92 of the thermal insulating member 70, thereby achieving a preferable thermal insulating effect.

As shown in FIG. 5, when the thermal insulating member 70 and the upper thermal insulating member 76 are attached to the fuel tank 62, an upper end edge 94 of the thermal insulating member 70 is covered with a lower end edge 96 of the upper thermal insulating member 76, whereby the fuel tank 62 can be covered with the thermal insulating member 70 and the upper thermal insulating member 76 without forming any gap. Therefore, the upper portion 78, the side portion 72, and the bottom portion 74 of the fuel tank 62 can be covered with the thermal insulating member 70 and the upper thermal insulating member 76, and consequently, the surfaces of the fuel tank 62 can be entirely covered with the thermal insulating member 70 and the upper thermal insulating member 76, thereby exhibiting a thermal insulating effect efficiently.

As shown in FIG. 8, the thermal insulating member 70 includes a foamed layer 98 provided on the interior side thereof, and an outer layer 100 made of a solid material.

The outer layer 100 is composed of an olefin synthetic resin or a blending material of olefin synthetic resins, and has a thickness ranging from 0.5 mm to 2.0 mm.

Therefore, the outer layer 100 exhibits rigidity and durability to prevent the damage to the foamed layer 98. Where the thickness of the outer layer 100 is less than 0.5 mm, the rigidity of the outer layer 100 is weak so that the damage to the foamed layer 98 may not be prevented. Where the thickness of the outer layer 100 exceeds 2.0 mm, the weight of the outer layer 100 increases, and it takes much time and labor for carrying out vacuum molding, etc. to conform to the configuration of the fuel tank 62.

Examples of the olefin synthetic resin include polyethylene and polypropylene, and examples of the blending material of olefin synthetic resins include a blending material of polyethylene and polypropylene, and a material containing polyethylene and polypropylene as a main ingredient, to which other synthetic resins are blended.

The foamed layer 98 is composed of an olefin synthetic resin or a blending material of olefin synthetic resins, which is of the same kind with that of the material of the outer layer 100. Examples of the olefin synthetic resin include polyethylene and polypropylene, and examples of the blending material of olefin synthetic resins include a blending material of polyethylene and polypropylene, and a material containing polyethylene and polypropylene as a main ingredient, to which other synthetic resins are blended.

Since the foamed layer 98 and the outer layer 100 are composed of materials of the same kind with each other, they can be welded to each other strongly. The foamed layer 98 and the outer layer 100 can be prepared by integrally welding or bonding sheets, cutting welded or bonded sheets to have a prescribed size, and configuring them with vacuum molding, etc.

The expansion ratio of the foamed layer 98 ranges from 15 to 40. Since the expansion ratio ranges from 15 to 40, sufficient thermal insulating properties and sufficient weight reduction can be realized. Where the expansion ratio is less than 15, sufficient thermal insulating properties cannot be achieved, and the effect of weight reduction reduces. Where the expansion ration exceeds 40, the amount of isolated cells in the foamed layer 98 decreases to reduce the thermal insulating effect, and lower the rigidity of the foamed layer 98.

Since the thermal insulating member 70 includes the foamed layer 98 on the interior side thereof, and the outer layer 100 composed of a solid material, the exterior surface of the thermal insulating member 70 exhibits high rigidity. Therefore, when stones, etc. spring up from road surfaces and strike the thermal insulating member 70 during running of motor vehicles, or when the thermal insulating member 70 interfere with road surfaces during running of motor vehicles on uneven road surfaces, damage to the thermal insulating member 70 can be prevented.

As described later, the thermal insulating member 70 and the upper thermal insulating member 76 along with the fuel tank 62 are attached to the floor panel 12 by means of a tank attaching member. Therefore, when the fuel tank 62 is attached to the floor panel 12, the thermal insulating member 70 and the upper thermal insulating member 76 can be also attached by attaching them to the fuel tank 62 simultaneously, thereby facilitating the attachment of the fuel tank 62, the thermal insulating member 70 and the upper thermal insulating member 76.

A belt-shaped tank band 101 as a tank attaching member is secured to a bottom of the thermal insulating member 70 for attaching the fuel tank 62, the thermal insulating member 70 and the upper thermal insulating member 76 to the floor panel 12. The configuration of the tank attaching member is not limited to the belt-shaped configuration, but may be arbitrarily selected provided that it can hold the fuel tank 62.

The tank band 101 has a bottom section 102, side sections 104 extending from both ends of the bottom section 102, and end sections 106 provided at ends of the side sections 104.

The end sections 106 of the tank band 101 are secured to band attachment members 108 provided on a rear surface of the floor panel 12 with screws 110. An upper surface of the fuel tank 62 contacts the floor panel 12, whereas a bottom surface thereof is held with the tank band 101, whereby the fuel tank 62 is secured to the floor panel 12.

The number of the tank bands 101 depends on the dimensions of the fuel tank 62, but it is preferable to use two or more tank bands 101. By using two or more tank bands 101, the bottom section 102 thereof can securely hold the fuel tank 62 and the thermal insulating member 70. The number of the tank bands 101 can be arbitrarily increased according to the configuration of the fuel tank 62.

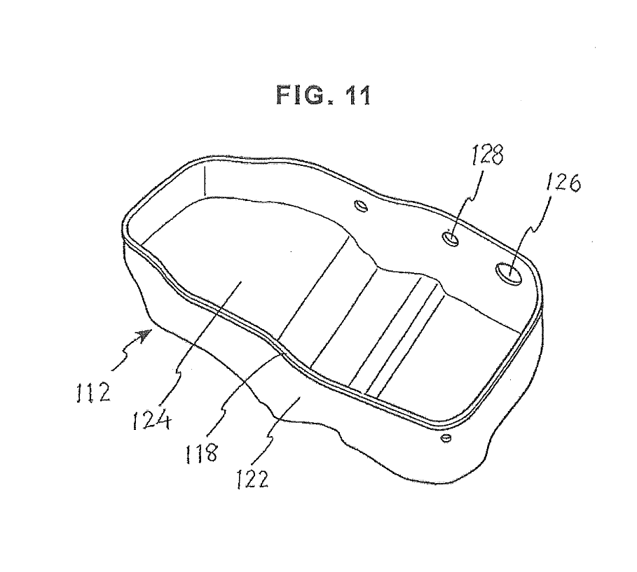

A second embodiment of a thermal insulating member 112 adapted to cover the fuel tank 62 for thermal insulation will be explained with reference to FIGS. 10 through 11.

As shown in FIG. 10, in the present embodiment, the thermal insulating member 112 is formed so as to cover the side portion 72 and the bottom portion 74 of the fuel tank 62, and an upper portion 78 of the fuel tank 62 contacts the floor panel 12 via shock absorbing members 116.

No upper thermal insulating member is provided to cover the upper portion 78 of the fuel tank 62. An upper end edge 118 of the thermal insulating member 112 is formed uneven so as to conform to the configuration of the floor panel 12 to which the fuel tank 62 is adapted to be attached. A seal member 120 for attachment to the upper end edge 118 will be explained later.

The thermal insulating member 112 thus configured can completely cover the side portion 72 and the bottom portion 74 of the fuel tank 62. The upper end edge 118 of the thermal insulating member 112 is attached to the floor panel 12 to seal between the floor panel 12 and the upper end edge 118 so that the upper portion 78 of the fuel tank 62 achieves an excellent thermal insulating effect.

In addition, a side portion 122 and a bottom portion 124 of the thermal insulating member 112 are previously formed by vacuum molding, etc. so as to become integral in conformity with the configuration of the fuel tank 62. Therefore, the side portion 122 and the bottom portion 124 can be formed simultaneously by one molding, thereby facilitating the production thereof. And no gap is generated between the side portion 122 and the bottom portion 124 so that air does not enter between the side portion 122 and the bottom portion 124, thereby achieving a preferable thermal insulating effect.

The thermal insulating member 112 has an inlet hole 126, a pipe hole 128, etc. for passing the inlet pipe connecting member 68, the fuel pipe 69, and other tubes or cables attached to the fuel tank 62. With this arrangement, members attached to an exterior surface of the fuel tank 62 can be readily passed through the thermal insulating member 112. And any gap can be prevented from being generated between the fuel tank 62 and the thermal insulating member 112, thereby achieving an improved thermal insulating effect.

The thermal insulating member 112 includes an outer layer 130 made of a solid material of an olefin synthetic resin or a blending material of olefin synthetic resins, and a foamed layer 132 made of a foamed material made of an olefin synthetic resin or a blending material of olefin synthetic resins, similarly to the first embodiment. Since the foamed layer 132 and the outer layer 130 are composed of materials of the same kind with each other, they can be welded to each other strongly.

As shown in FIG. 11 the seal member 120 can be attached to the upper end edge 118 of the side portion 122 of the thermal insulating member 112, which is adapted to contact the floor panel 12.

The upper end edge 118 of the side portion 122 bends outwardly along its upper edge to define a horizontal plane relative to the floor panel 12, and the seal member 120 is attached to the horizontal part of the upper end edge 118.

It is preferable to compose the seal member 120 for attachment to the upper end edge 118 of a sponge material, a double-sided adhesive tape or an adhesive.

Where the seal member 120 is composed of the sponge material, the seal member 120 can flexibly bend to conform to an uneven surface of the floor panel 12, and contact the same when an end edge of the side portion 122 is pressed against the floor panel 12, thereby closing any gap between the floor panel 12 and the thermal insulating member 112, and improving the thermal insulating effect.

Where the seal member 120 is composed of the double-sided adhesive tape, by merely pressing the end edge of the side portion 122 of the thermal insulating member 112 against the floor panel 12, the double-sided adhesive tape can be bonded thereto, thereby readily bonding the upper end edge 118 of the thermal insulating member 112 to the floor panel 12. As a result, the attaching work of the thermal insulating member 112 is facilitated, and the upper end edge 118 of the side portion 122 is brought into close contact with the floor panel 12 to improve the thermal insulating effect. In addition; where the double-sided adhesive tape is composed of a sponge material and formed thick, gaps between the floor panel 12 and the thermal insulating member 112 can be closed to improve the thermal insulating effect.

Where the seal member 120 is composed of the adhesive, by merely pressing the adhesive at an end of the side portion 122 of the thermal insulating member 112 against the floor panel 12, the side portion 122 can be bonded to the floor panel 12. As a result, the end of the side portion 122 can be brought into close contact with the floor panel 12 to improve the thermal insulating effect.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A thermal insulating structure of a fuel tank for a motor vehicle, which is mounted under a floor panel of the motor vehicle, comprising:
a thermal insulating member previously formed for covering at least an entire side surface and an entire bottom surface of the fuel tank, said thermal insulating member including a foamed layer on an interior side thereof, and an outer layer made of a solid material, and being attached to the floor panel along with the fuel tank by means of a tank attaching member.

2. The thermal insulating structure as claimed in claim 1, wherein an upper surface of the fuel tank is covered with another thermal insulating member having a foamed layer.

3. The thermal insulating structure as claimed in claim 1, wherein an upper surface of the fuel tank contacts the floor panel, and an upper end of a side portion of said thermal insulating member contacts the floor panel.

4. The thermal insulating structure as claimed in claim 1, wherein said thermal insulating member has holes for passing members attached to an outer surface of the fuel tank therethrough.

5. The thermal insulating structure as claimed in claim 1, wherein said outer layer is composed of one of an olefin synthetic resin and a blending material of olefin synthetic resins, and has a thickness ranging from 0.5 mm to 2.0 mm.

6. The thermal insulating structure as claimed in claim 1, wherein said foamed layer is composed of one of an olefin synthetic resin and a blending material of olefin synthetic resins, and has an expansion ratio ranging from 15 to 40.

7. The thermal insulating structure as claimed in claim 1, wherein a tank attaching member is a plurality of belt members adapted to hold a bottom portion of said thermal insulating member in a plurality of positions, and ends of each of said belt members are secured to the floor panel.
